(19) United States
(12) Patent Application Publication
(10) Pub. No.: US 2007/0097822 A1
(43) Pub. Date: May 3, 2007

(54) Evaluation and adjustment methods in optical disc apparatus, and optical disc apparatus

(75) Inventor: Toshiaki Iwanaga, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 11/590,848

(22) Filed: Nov. 1, 2006

(30) Foreign Application Priority Data
Nov. 2, 2005 (JP) 2005-319378

(51) Int. Cl. G11B 7/00; G11B 20/10

(52) U.S. Cl. 369/53.2; 369/53.31; 369/59.22

(57) ABSTRACT

In an operation method of an optical disc apparatus in which an optical disc is loaded, an optical disc is loaded in the optical disc apparatus; and the optical disc apparatus is evaluated based on a performance evaluation index for the loaded optical disc. The evaluation is achieved by acquiring an identification data used to identify a kind of the loaded optical disc; by selecting one of methods of calculating a performance evaluation index based on the identification data; by determining the performance evaluation index by using the selected method; and by evaluating an RF (radio frequency) signal obtained from the loaded optical disc based on the performance evaluation index.

### BACKGROUND OF THE INVENTION

1. Field of the Invention

The present invention relates to an optical disc apparatus compatible with various kinds of standardized optical discs, and more specifically to an operation method of the optical disc apparatus for optimum data recording and/or reproduction.

2. Description of the Related Art

At present, an optical disc apparatus which records or reproduces data by using an optical disc detects a read signal from a laser beam modulated and reflected by the optical disc to acquire various kinds of data. With a read-only optical disc, the read signal is extracted by using a change in the light amount of the laser beam reflected from convex and concave pits (prepit) previously formed on the recording surface of the optical disc. With a write-once optical disc, the read signal is extracted by using a change in the light amount of reflected laser beam attributable to phase change in a micro pit or a recorded mark formed through laser irradiation with high power. With a phase change type optical disc as one type of rewritable optical discs, as well as in the write-once optical disc, the read signal is extracted by using a change in the light amount of reflected laser beam attributable to phase change in a recorded mark. The terms “write-once” and “rewritable” may be collectively referred to as “recordable.”

As optical discs standardized based on the principles described above, there are CDs (Compact Discs), and a semiconductor laser diode having of the wavelength of 780 nm and an objective lens having the numerical aperture NA of approximately 0.45 are provided for the CD. Representative types of the CDs include a read-only CD-ROM, a write-once CD-R, and a rewritable CD-RW. In addition, DVDs (Digital Versatile Discs) have been standardized by a DVD forum for the aim of achieving a larger capacity. This type of optical disc is standardized with the light source of the wavelength of 650 nm and the objective lens having the numerical aperture of 0.6. The DVDs are classified into a read-only DVD-ROM, a write-once DVD-R, and a rewritable DVD-RAM and DVD-RW. The DVD-ROM is a replica disc formed to have prepits. On the other hand, the recordable DVD has a groove spirally formed on the recording surface of the optical disc as a recording track that a data pattern is recorded with a recorded mark. A laser beam reflected and diffracted due to phase difference between the groove and a land formed between the grooves is used for a track position control. It should be noted that the land and the groove may be respectively called as a convex portion and a concave portion, or an inter-groove portion and a groove portion. Two methods are standardized and commercialized for the DVD: in a groove recording method as one of them, only grooves are used as recording tracks for recording and reproduction; and in a land/groove recording method as the other of them, both lands and grooves are used as recording tracks. The groove recording method is adopted for the write-once DVD-R, +R disks, and the rewritable DVD-RW, +RW disks. On the other hand, the land/groove recording method is adopted for the DVD-RAM. Any groove used in both the groove recording method and the land/groove recording method is formed to wobble slightly in a direction of the track width, and is modulated with a carrier signal of sine wave. Here, a groove formed to wobble is referred to as a wobble groove. In some standardized DVDs, address data of an optical disc is modulated by phase inversion caused by the wobble groove. A wobble signal read out from the wobble groove is used for a disc rotation control, a recording clock signal generation, and address detection.

FIG. 1 is a functional block diagram showing the configuration of a conventional optical disc apparatus. Referring to FIG. 1, the configuration of the conventional optical disc apparatus will be described about common functions to various kinds of optical discs. A laser beam emitted from an laser diode 1060 in an optical head 1010 is focused on the recording surface of an optical disc 100, and the laser beam reflected from the recording surface is split by a beam splitter 1030 and then received by a photo-detector section 1080 (1080a and 1080b) split into two with respect to a radial direction perpendicular to a recording track on the optical disc (hereinafter, simply referred to as a disc radial direction) A current output obtained from the individual photo-detector 1080a or 1080b in the photo-detector 1080 is converted into a voltage output by a corresponding I-V amplifier 1090 or 1100. A wobble signal, which changes in accordance with the wobble of a groove (wobble groove), is obtained through subtraction between output signals from the I-V amplifiers 1090 and 1100 by a differential amplifier 1120. It should be noted that a low frequency component of the wobble signal is synonymous with a track error signal. Here, a data read signal is obtained in accordance with a change in the light amount of laser beam reflected by a recorded mark by adding together output signals from the I-V amplifiers 1090 and 1100 by an addition amplifier 1110. The data read signal from the recorded mark may be referred to as an RF signal. Servo control for a positioning process of the laser beam on the disc recording surface and the recording track is omitted from the description. In relation to this, the function of a thread motor 1070 which carries out positioning in the disc radial direction by a servo processing circuit is also omitted from the present description.

In order that the laser beam emitted through an objective lens 1040 of the optical head 1010 is focused on a groove or land as a recording track, the objective lens 1040 is subjected to a focus control by an objective lens actuator 1020 controlled through the servo control, which is omitted from the description, and also subjected to a track position control by use of the reflected and diffracted laser beam described above. The rotation speed of the optical disc rotated by a spindle motor 1240 is controlled by a spindle control section 1230 so that the linear velocity at which the laser beam scans the recording track becomes equal to a predetermined fixed value. To easily perform this rotation control, a carrier signal (wobble clock signal) generated based on the wobble signal is used. Since the wobble groove wobbles with a fixed spatial frequency, the linear velocity can be kept fixed by controlling the rotation speed so that the frequency of a reproduced carrier signal becomes equal to the predetermined fixed value. If the linear velocity is kept fixed, a data pattern recorded in synchronization with the recording clock signal with a frequency kept fixed is formed as a recorded mark having a predetermined linear density.

A wobble signal processing section 1160 is composed of a band pass filter which has a pass band near the wobble frequency; a PLL (Phase Locked Loop) circuit for obtaining a wobble clock signal synchronous with the wobble signal; a sampling circuit which samples an output of the band pass filter in synchronization with the wobble clock signal; and a synchronizing circuit which binarizes and synchronizes an output of the sampling circuit. The wobble signal processing section 1160 outputs a channel clock signal to serve as a recording clock signal, the wobble clock signal, and binarized synchronous wobble data. A wobble data demodulating section 1170 decodes the binarized synchronous wobble data in accordance with modulation rules, upon which a synchronous signal pattern of a wobble signal is also decoded by a method such as pattern matching. A wobble ID detecting section 1180 detects and outputs address data corresponding to a physical sector, such as a sector number and a track address, which are embedded in the wobble signal.

The wobble signal processing section 1160 operates to control the rotation speed of a spindle by the spindle control section 1230 so that the frequency of the wobble clock signal obtained by the PLL circuit becomes fixed. Thus, the scan speed of the laser beam is kept to a substantially fixed linear velocity. A disc system control section 1190 generates an data pattern based on the address data obtained from the wobble ID detecting section 1180 and data from a host (not shown). A recording control section 1210 controls an laser diode driver 1220 to modulate the intensity of the laser beam from the laser diode 1060 in accordance with the data pattern generated by the disc system control section 1190, and forms the data pattern on the optical disc in the fixed linear density as a recorded mark. Here, the recording clock signal is generated by multiplying the wobble clock signal by a value. Thus, the data pattern can be recorded in accordance with the linear velocity detected from the wobble signal frequency, and high positioning accuracy can be attained. Thus, the accuracy in the position on which the data pattern is recorded can be suppressed to a value smaller than an amount of phase fluctuation of the optical disc due to track decentering. The data to be recorded on the optical disc is supplied through an interface (not shown) to the disc system control section 1190 from the host.

On the other hand, the RF signal as a data read signal of the recorded mark includes a total light amount of laser beam reflected from the optical disc, and is outputted from an addition amplifier 1110. This RF signal is AC-coupled by an element such as a capacitor (not shown), and is passed to an RF signal processing section 1130 at a latter shtage. The RF signal processing section 1130 is composed of an AGC (Automatic Gain Control) circuit, a waveform equalizer having a predetermined frequency characteristic, a PLL (Phase Locked Loop) circuit for obtaining a reproduction channel clock signal, and a binarizing circuit. The RF signal processing section 1130 outputs a reproduced data signal as a binarized clock synchronization data signal. For CDs and DVDs, the binarizing circuit is typically provided with a configuration adopting a slicer method, that is, a configuration to binarized the RF signal into the data by a comparator. However, for the DVD, a PRML (Partial Response Maximum Likelihood) method is adopted to compensate a lack of reproduction margin involved with a high multiple speed recording. Thus, the optical disc apparatuses provided with binarizing means such as a Viterbi detector have been commercialized. For HD DVD (High Definition DVD) as the next-generation DVD using a blue laser, the PRML method is adopted as standard, and the Viterbi detector is used for the binarizing circuit, to ensure reproduction performance equal to or greater than the reproduction margin.

An RF data demodulating section 1140 decodes a binarized reproduced signal synchronous with a clock signal by using a decoder circuit, carries out error correction to the decoded signal by an error correction circuit, and then outputs the error corrected signal as a reproduced data signal to the host (not shown). The reproduced data signal from the RF data demodulating section 1140 is supplied to a data ID detecting section 1150 in parallel, and is used to obtain an address data embedded in the reproduced data signal such as a sector number.

The optical disc apparatus which records a data signal on a recordable optical disc, typically uses a performance evaluation index to carry out optimum recording while maintaining disc compatibility. As one of performance evaluation indexes for evaluating characteristics of the optical disc or the optical head, a jitter value of the RF signal (a fluctuation component in a time axis direction) obtained from the optical disc is defined in the standards. For example, in case of the optical disc apparatus using a CD-R, a CD-RW, a DVD-R, and a DVD-RW in which the RF signal is binarized into the data signal by a slicer method, the jitter value measured from the binarized data signal and a PLL clock signal is used as the performance evaluation index. Here, the jitter value is a variance obtained by sampling the edge-to-edge width or the pulse width of a binarized signal based on an equalized signal from a waveform equalizing circuit having a predetermined frequency characteristic for a predetermined period and calculated as a frequency distribution for a detection window. Thus, since a noise variance and an amount of edge shift can be extracted, the performance evaluation index is essential for deriving an optimum recording parameter for a recorded mark/space. Moreover, the jitter value and an error rate in reproduction are proportional to each other, so that the jitter value is a minimum value when the error rate is a minimum value. Thus, with the optical disc apparatus described above, recording power adjustment or recording strategy adjustment is carried out by a hill-climbing method with a minimum jitter value as a target.

On the other hand, for the optical disc apparatus using the HD DVD as described above, data reproduction is accomplished by adopting the PRML method as a standard. For the HD DVD, it is difficult to provide the jitter value as the performance evaluation index. FIG. 8A is a conceptual diagram showing a histogram for each mark length of the optical disc such as a DVD-RW, which has a relatively high resolution. FIG. 8B is a conceptual diagram showing a histogram for each mark length of the high-density optical disc such as the HD DVD rewritable, which has a low resolution. FIGS. 8A and 8B indicate that, when a signal is detected through binarization by using the slicer method for the optical disc with the low resolution, it is difficult to separate a 3T signal as well as a 2T signal as a minimum mark/space, and the edge-to-edge width or the pulse width is not separated in the detection window. Thus, FIGS. 8A and SB indicate that it cannot be used as the index. This is because the resolution defined based on a ratio between a long mark amplitude and a short mark amplitude is as extremely small as −30 dB or below, in which reproduction is carried out by using an objective lens with the numerical aperture NA of 0.65 and an laser diode with the wavelength of 405 nm. Thus, it could be understood that, for the optical disc system presuming the PRML as a requisite, a jitter index cannot be used. Therefore, it has been proposed that a PRSNR (Partial Response Signal to Noise Ratio value) is standardized as a performance evaluation index for the optical disc apparatus using the HD DVD.

The PRSNR is an index which is used to express an S/N ratio (a ratio of a signal to a disturbing noise) of the reproduced signal and an actual reproduced waveform and a theoretical PR waveform linearity, and which is one of indexes required for estimation of a disc bit error rate. The PRSNR is a difference between the actual reproduced signal and a target signal generated by carrying out special processing to amplitude data obtained from a reproduced waveform based on the RF signal. More specifically, as described in Japanese Laid Open Patent Application (JP-P2004-213862A), in combination of a PR equalizer which executes PR (Partial Response) equalization, and a Viterbi decoder which executes ML (Maximum Likelihood) decoding, the PRSNR is calculated from a ratio of an erroneous inter-path distance with a short Euclidean distance and a noise. The PRSNR can be calculated directly from the RF signal. Therefore, a high value is obtained under a favorable reproduction state, while a low value is obtained under a bad reproduction state. This is also associated with a disc tilt, a recorded mark recording state, and optical head characteristics. Thus, the high value is obtained under an optimum adjustment state, while the low value is obtained under a state apart from the optimum state. In Japanese Laid Open Patent Application (JP-P2004-253114A), an SbER (Simulated bit Error Rate) calculation method as the different performance evaluation index for an HD DVD in addition to the PRSNR is described, containing specifications for a PI error.

Here, the optical disc apparatus which achieves compatibility with the various kinds of standardized optical discs described above, is called a multi-disc-format optical disc apparatus. Commercialization of the optical disc apparatuses for a DVD as multi-disc-format optical disc apparatuses has been progressing by elaborating an optical head or an LSI to achieve compatibility with the various kinds of CDs described above. Moreover, in recent years, as next-generation standards for even larger DVD capacity, an HD DVD applied with a blue-purple semiconductor laser has been standardized. Currently standardized as the HD DVD are: a read-only HD DVD-ROM, a write-once HD DVD-R, and an HD DVD rewritable in an L/G recording method. In the future, as in case of optical disc apparatuses for the DVD, multi-disc-format optical disc apparatuses which are also compatible with the HD DVD discs are expected to be widespread.

For this multi-disc-format optical disc apparatus, several kinds of configurations are possible. FIGS. 10A and 10B are conceptual diagrams showing a multi-disc-format optical disc apparatus. Referring to FIG. 10A, the optical disc apparatus composed of two optical-heads 1010a and 1010b is shown. As one example of the configuration of the optical disc apparatus, the optical head achieving disc compatibility with the CD and the DVD is provided in the optical head 1010a and the optical head for a HD DVD only is provided in the optical head 1010b. A signal switch is provided for switching connection with an apparatus circuit board, which allows switching to circuit configuration such that an LSI on the apparatus circuit board complies with its individual format. Referring to FIG. 10B, one optical head 1010 is provided, in which a rotary objective lens actuator 1021 is mounted for two objective lenses (for example, for DVD/CD and for an HD DVD, respectively), which are used by being switched in a rotating manner. Other than those described above, there are optical disc apparatuses each composed of one objective lens and a plurality of kinds of laser diodes corresponding to a plurality of wavelengths and to optimize each of optical parameters corresponding to various kinds of optical discs by changing the numerical aperture NA of the objective lens.

In a multi-disc-format optical disc apparatus, it is presumed that various kinds of standardized discs can be used therein. For example, when the HD DVD is in use, the ROM-type, the R-type, and the RW-type need to be compatible with one another. With the optical disc apparatuses of the same beam diameter, a difference in the recording linear density mainly affects the resolution of a reproduced waveform. Thus, depending on a combination of a medium having a different linear density and a head, an optimum reproduction state is not necessarily provided based on the PRSNR specified by the written standards. More specifically, the PRSNR in the HD DVD is calculated by targeting on a PR characteristic under the constraint length of 5, as in case of a PR (12221). Thus, the PRSNR is an optimum performance evaluation index for a reproduction channel characteristic specified by the PR (12221), although it does not serve as an optimum index for a reproduction channel characteristic specified by a different PR characteristic. Here, a PR (h0h1h2h3h4 . . . ) is a PR characteristic expressed by an impulse response row arranged in a bracket.

FIG. 6 shows results of simulation of a bit error rate bER to a data bit density in various kinds of PRML methods. Referring to FIG. 6, with the PRML method to the PR (12221), there is a large difference in a bit error rate bER among the recorded data bit densities (large performance difference depending on the data bit density). Thus, in the range where high dense is accomplished and a resolution is small, the PRML method to the PR (12221) provides more favorable performance than the PRML method to a PR (1221) or a PR (3443). However, this effect is smaller on the low density side, and thus the PRML method under the constraint length of 4 to the PR (1221) and the PR (3443) provides more favorable performance. Therefore, it is important to use a performance evaluation index adaptive to a reproduction channel. However, there are limitations in evaluating the quality of a reproduced signal and optimizing the waveform equalization performance for each of the optical discs of different recording densities by using a performance evaluation index defined by the written standards or by using the same applicable performance evaluation index. In addition, for the HD DVD, two kinds of recording densities are specified. Thus, favorable performance cannot be provided by performing the evaluation and the optimization by using the same performance evaluation index.

An HD DVD rewritable in the L/G recording method is configured to have the single-layer record capacity of 20 GB, the data bit density of 0.13 um/bit, and the L/G track pitch of 0.34 um. On the other hand, an HD DVD-ROM, and an HD DVD-R are configured to have the single-layer capacity of 15 GB, the double-layer record capacity of 30 GB, the data bit density of 0.153 um/bit, and the groove pitch of 0.4 um. In this case, when the objective lens numerical aperture NA of 0.65 is in use, he. resolution-is large for the HD DVD-ROM and the HD DVD-R but low for the HD DVD rewritable. Thus, a problem is caused that it is not optimum for the reproduction channel characteristic specified by the PR (12221). Consequently, it is possible to build up optimum reproduction channel environment by configuring the PRML method itself in the drive to use the PRML method specified to the PR (1221) or the PR (3443). In this case, the use of the. PRSNR method specified to this PR (12221) as a performance evaluation index fails to provide correlation with a reproduction error rate. Thus, the PRSNR cannot be used as a performance evaluation index. More specifically, when a PRSNR specified by the written standards, such as a tilt characteristic, a defocusing characteristic, and OPC is used as an index, especially when a ROM/R is in use, the correlation with the error rate decreases. Thus, a problem is caused that a considerable adjustment time is required to compensate for adjustment accuracy insufficiency.

Moreover, according to the standard, although the DVD does not require the PRML method, adoption of the PRML method for the optical disc drive has been started for various reasons, such as reproduction margin insufficiency accompanying the high multiple speed recording, use of a low-price, bad disc, adjustment cost reduction, or the like. However, apparatus adjustment is carried out based on the jitter index as a current performance evaluation index measured from a PLL clock signal and a data signal sequence obtained by binarizing an RF signal by a slicer method. From a viewpoint of the PRML method, there is a difference in accuracy between a result of jitter measurement detected by the slicer method and a PRSNR conditioned to the PRML method. The jitter value has low correlation with the reproduction error rate. As described above, the correlation with the error rate decreases due to reduced resolution, thus causing a large problem of the apparatus adjustment.

On the other hand, a twin disc which is a double layer disc formed by adhering optical discs of two different types with a favorable plane accuracy so as to permit access thereto from one side has been standardized by the HD DVD. A DVD-ROM is provided in an LO layer from the light incidence surface side, and an HD DVD-ROM is provided in an L1 layer. Also, with this kind of disc, the apparatus adjustment is required for optimum reproduction to switch between a first layer and a second layer in a single apparatus. However, the apparatus adjustment for the DVD has been carried out using the jitter index, whereas the performance evaluation for the HD DVD is specified by the PRSNR. Thus, the correlation of the jitter value and the PRSNR with the reproduction error rate decreases, resulting in the above-described problem about the apparatus adjustment. This will be described using a tilt adjustment as an example. When the tilt adjustment is carried out for the DVD by using the jitter index, the tilt adjustment needs to be repeated on the HD DVD side. The principle is that since the discs are adhered with a good positioning, the tilt adjustment that has been carried out on one disc need not be repeated on the other disc. However, the accuracy adjustment by using a jitter evaluation index is approximately ±0.2 degrees. Such accuracy means insufficient adjustment (adjustment failure) relative to the HD DVD, depending on an individual disc difference. However, the adjustment accuracy using the PRSNR is equal to or smaller than ±0.1 degree and the recording density on the DVD side is low, which can be conversely recognized as adjustment results of a high accuracy. As described above, when discs of different recording densities are adhered to each other and accuracies indicated by their respective evaluation indexes are different, a cooperative operation for the apparatus adjustment is difficult.

Japanese Laid Open Patent Applications (JP-P2002-074659A and JP-P2004-296068A) disclose technology of recording and reproduction on and from a plurality of kinds of optical discs. The optical disc apparatus disclosed in the Japanese Laid Open Patent Application (JP-P2002-074659A) previously sets processing items corresponding to the type of optical disc, and executes record and reproduction operations in accordance with the processing items of the type of the optical disc inserted. In this case, an initial adjustment operation is carried out based on control data and adjustment data that are set or recorded in accordance with the type of optical disc. Thus, the adjustment cannot be achieved with favorable accuracy in conformity with individual characteristics of the optical discs, the state of the inserted optical disc, and an ambient environment (optical environment, temperature) Moreover, the optical disc apparatus disclosed in Japanese Laid Open Patent Application (JP-P2004-296068A) writes a plurality of data with preset write values on the optical disc based on a command supplied from a host computer, measures a recording quality evaluation index such as the jitter value and the error rate, and executes various adjustments. Thus, the optical disc apparatus disclosed in Japanese Laid Open Patent Application (JP-P2004-296068A) cannot measure a quality evaluation index for an optical disc on which writing cannot be performed. Moreover, data writing needs to be executed several times to obtain the quality evaluation index. Thus, much time for adjustment is required.

### SUMMARY OF THE INVENTION

It is an object of the present invention to provide a multi-disc-format optical disc apparatus which can adjust various standardized optical discs in accordance with a favorable accuracy.

Another object of the present invention is to provide a multi-disc-format optical disc apparatus which can acquire a reproduce signal of favorable quality from various standardized discs.

Still another object of the present invention is to provide a multimedia optical disc apparatus with favorable reliability in compatibility with various standardized discs.

It is also an object of the present invention to provide an evaluation and adjustment method of a reproduced signal, in which the time required for adjustment of an optical disc can be reduced in the multimedia optical disc apparatus.

In an aspect of the present invention, an operation method of an optical disc apparatus in which an optical disc is loaded, is achieved by loading an optical disc in the optical disc apparatus; and by evaluating the optical disc apparatus based on a performance evaluation index for the loaded optical disc. The evaluating is achieved by acquiring an identification data used to identify a kind of the loaded optical disc; by selecting one of methods of calculating a performance evaluation index based on the identification data; by determining the performance evaluation index by using the selected method; and by evaluating an RF (radio frequency) signal obtained from the loaded optical disc based on the performance evaluation index.

Here, the operation method may be achieved by further setting a plurality of identification data for a plurality of kinds of optical discs. The acquiring an identification data may be achieved by extracting said identification data from said plurality of identification data based on a signal obtained from the loaded optical disc.

Also, the acquiring an identification data is achieved by acquiring the identification data which has been recorded in a predetermined area of the loaded optical disc.

Also, the acquiring an identification data may be achieved by acquiring an optical condition as the identification data from the loaded optical disc. The selecting may be achieved by determining a wavelength λ of a laser beam and a numerical aperture NA of an object lens based on said optical condition; and by selecting one of the methods of calculating the performance evaluation index based on the determined wavelength λ and numerical aperture NA.

In this case, the selecting one of the methods of calculating the performance evaluation index based on the determined wavelength λ and numerical aperture NA is achieved by selecting a jitter calculating method when λ/NA is larger than 1.4 microns; by selecting a method of calculating the performance evaluation index in a restriction length of 3 or 4 when λ/NA is larger than 0.9 microns and smaller than 1.4 microns; and by selecting a method of calculating the performance evaluation index in the restriction length of 4 or 5 when λ/NA is smaller than 0.9 microns.

Also, the selecting one of the methods of calculating the performance evaluation index may be achieved by selecting one of a plurality of PRML (Partial Response Maximum Likelihood) decoding processes defined based on a plurality of PR (Partial Response) characteristics based on said identification data. The determining may be achieved by determining a PRSNR (Partial Response Signal to Noise Ratio) based on the selected PRML decoding process as the performance evaluation index.

Also, the selecting one of the methods of calculating the performance evaluation index may be achieved by selecting a PR equalization method and a Viterbi detection method from a plurality of PR equalization methods and a plurality of Viterbi detection methods based on the identification data. The determining may be achieved by determining the performance evaluation index by a process using the selected PR equalization method and Viterbi detection method.

Also, the selecting one of the methods of calculating the performance evaluation index may be achieved by selecting one of the methods of calculating SbER (Simulated bit Error Rate) based on the identification data.

Also, the selecting one of the methods of calculating the performance evaluation index may be achieved by selecting a method of calculating jitter based on the identification data.

Also, the operation method may be achieved by further adjusting said optical disc apparatus by using the performance evaluation index such that a reproduction data signal can be obtained from the loaded optical disc.

In another aspect of the present invention, an optical disc apparatus includes an optical head configured to irradiate a laser beam to an optical disc loaded on the optical disc apparatus, and to detect an RF (radio frequency) signal from the loaded optical disc. An RF signal processing section calculates a performance evaluation index to the RF signal based on identification data for a type of the loaded optical disc, and acquires a data signal having been recorded on the loaded optical disc from the RF signal. A disc system control section controls relative optical position relation of the optical head and the loaded optical disc based on the performance evaluation index.

Here, the disc system control section outputs a control signal to the RF signal processing section based on the identification data. The RF signal processing section includes a plurality of performance evaluation index calculating sections and selects one of the plurality of performance evaluation index calculating sections in response to the control signal from the disc system control section, such that the selected performance evaluation index calculating section calculates the performance evaluation index to the RF signal.

In this case, the disc system control section comprises a register set which stores a plurality of identification data to a plurality of kinds of optical discs, extracts one of the plurality of identification data from the register set based on the loaded optical disc, and outputs the control signal to the RF signal processing section based on the identification data.

Also, the disc system control section acquires the identification data which has been recorded in a predetermined area of the optical disc through the optical head, and outputs the control signal to the RF signal processing section based on the identification data.

Also, the optical head outputs the laser beam to the optical disc to acquire said identification data when the optical disc is loaded in the optical disc apparatus. The disc system control section outputs the control signal to the RF signal processing section based on a wavelength λ of the laser beam and a numerical aperture NA of an object lens corresponding to the identification data.

Also, the RF signal processing section may include a jitter calculating section configured to calculate a jitter to the RF signal from the optical disc; and a PRSNR calculating section configured to calculate a PRSNR (Partial Response Signal to Noise Ratio) to the RF signal from the optical disc. The RF signal processing section outputs the jitter calculated by said jitter calculating section as the performance evaluation index, when λ/NA is larger than 1.4 microns, outputs PRSNR calculated by the PRSNR calculating section under a condition of a restriction length of 3 or 4 as the performance evaluation index, when the λ/NA is larger than 0.9 microns and equal to or smaller than 1.4 microns, and outputs PRSNR calculated by the PRSNR calculating section under a condition of the restriction length of 4 or 5 as the performance evaluation index, when the λ/NA is equal to or less than 0.9 microns.

Also, the RF signal processing section may include a plurality of PRSNR calculating sections configured to calculate a plurality of PRSNRs by executing a plurality of PRML (Partial Response Maximum Likelihood) decoding processes defined by a plurality of PR (Partial Response) characteristics, respectively. One of the plurality of PRSNR calculating sections is selected in response to the control signal, such that the selected PRSNR calculating section executes one of the plurality of PRML decoding processes which is defined by one of the plurality of PR characteristics corresponding to the control signal and calculates the PRSNR as the performance evaluation index.

Also, the RF signal processing section may further include an equalizer configured to generate a plurality of equalization signals to the RF signal from the optical disc; and a plurality of Viterbi detectors configured to generates Viterbi signals. The equalizer generates one of the plurality of equalization signals corresponding to the identification data, and one of the plurality of Viterbi detectors generatet the Viterbi signal corresponding to the identification data. The PRSNR calculating section calculates the PRSNR based on the equalization signal and the Viterbi signal and outputs as the performance evaluation index.

Also, the RF signal processing section may further include a plurality of SbER calculating sections configured to calculate SbERs (Simulated bit Error Rate) to the RF signal from the optical disc, respectively. One of the plurality of SbER calculating sections corresponding to the identification data calculates the SbER, and the RF signal processing section outputs the SbER as the performance evaluation index.

Also, the RF signal processing section includes a jitter calculating section configured to calculate a jitter to the RF signal from the optical disc based on the identification data, and the RF signal processing section outputs the jitter as the performance evaluation index.

Also, the disc system control section executes either of a tilt adjustment, a defocus adjustment, a detrack adjustment, a record power adjustment, and a record strategy adjustment.

### BRIEF DESCRIPTION OF THE DRAWINGS

FIG. 1 is a block diagram showing a conventional optical disc apparatus:

FIG. 2 is a block diagram showing the configuration of an optical disc apparatus according to an embodiment of the present invention;

FIG. 3 is a block diagram showing the configuration of an RF signal processing part in the optical disc apparatus according to the embodiment of the present invention;

FIG. 4 is a block diagram showing the configuration of a PRSNR calculating section in the optical disc apparatus according to the embodiment of the present invention;

FIG. 5 is a flowchart showing an apparatus operation carried out by the optical disc apparatus according to the embodiment of the present invention;

FIG. 6 is a diagram for showing a performance comparison made based on a difference in a PR characteristic of PRML and a data bit density;

FIG. 7 is a diagram for showing the effect provided by recording power adjustment according to the present invention;

FIGS. 8A and 8B are conceptual diagrams showing examples of results of jitter measurement made on a high-density optical disc with a low resolution;

FIG. 9 is a diagram showing an example of experimental results of a tilt correction with a PRSNR according to the present invention; and

FIGS. 10A and 10B are conceptual diagrams showing a method of switching a semiconductor laser or an objective lens in a multiple-disc type optical disc apparatus.

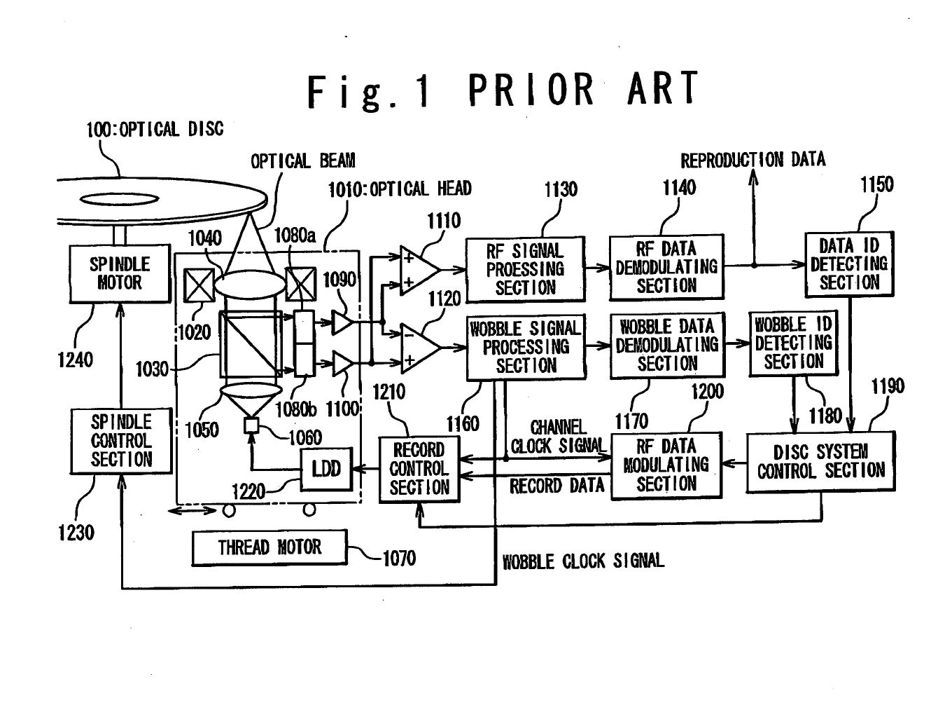

### DESCRIPTION OF THE PREFERRED EMBODIMENTS

Hereinafter, an optical disc apparatus according to the present invention will be described in detail with reference to the attached drawings. In the drawings, a same or similar reference numeral denotes a same, similar, or equivalent component.

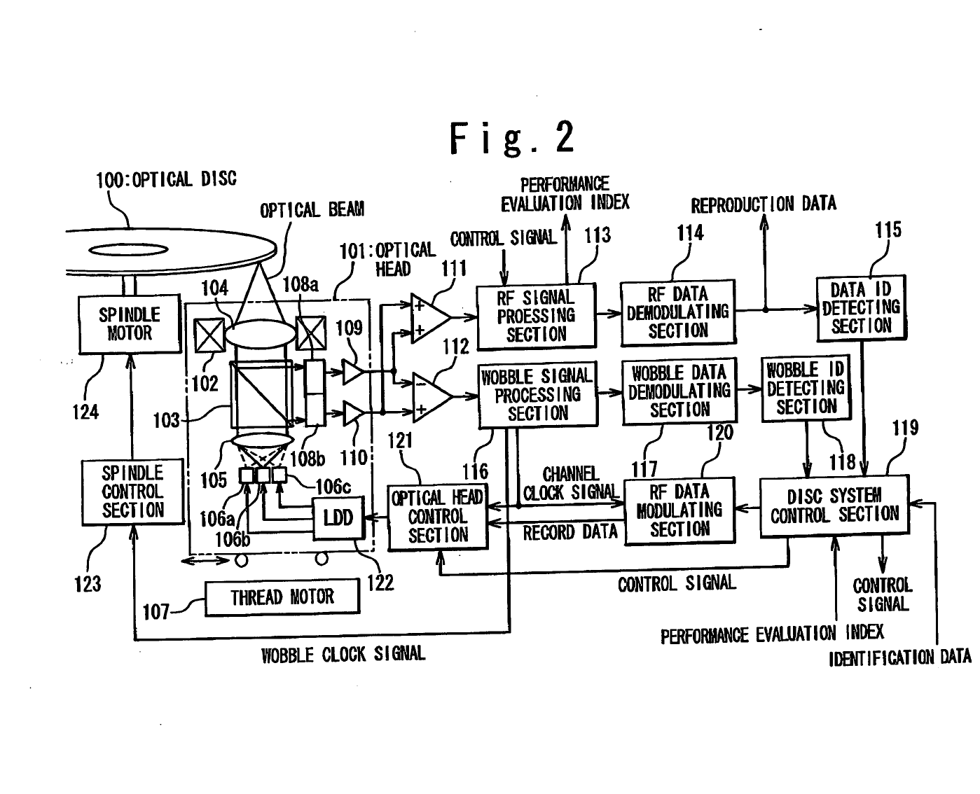

FIG. 2 is a block diagram showing the configuration of an optical disc apparatus according to the first embodiment of the present invention. Referring to FIG. 2, the optical disc apparatus according to the present invention is an optical disc recording/reproducing apparatus for multi-disc-format provided with an optical head 101 having a semiconductor laser (LD: Laser Diode) 106 for a plurality types of optical discs 100. The optical disc apparatus according to the present invention is provided with an additional amplifier 111, an RF signal processing section 113, and an RF data demodulating section 114, which are all provided for obtaining a reproduced data signal based on an output signal from the optical head 101. Also, the optical disc apparatus according to the present invention is provided with a differential amplifier 112, a wobble signal processing section 116, a wobble data demodulating section 117, a wobble ID detecting section 118, a disc system control section 119, an RF data modulating section 120, an optical head control section 121, a spindle control section 123, a spindle motor 124, and a thread motor 107, which are all provided for performing apparatus adjustment based on an output signal from the optical head 101.

The optical head 101 is provided with one objective lens 104 controlled by an objective lens actuator 102, a beam splitter 103, a collimate lens 105, three laser diodes 106a to 106c which output laser light of wavelengths compatible with various types of optical discs 100, a split photodetector 108, I-V amplifiers 109 and 110, and a semiconductor laser driver (LDD; Laser Diode Driver) 122 which drives the laser diodes 106a to 106c. The optical head 101 has the laser diodes 106 (106a to 106c) respectively corresponding to a plurality of light wavelengths, and is provided with a head configuration in which optimum optical parameters are set for the various types of optical discs by changing the numeric aperture NA of the objective lens 104 in accordance with each of the light wavelengths. The laser diodes 106 in the optical head 101 can emit laser beams of three wavelengths, i.e., the wavelength of 780 nm for the CD by the laser diode 106a, the wavelength of 650 nm for the DVD by the laser diode 106c, and the wavelength of 405 nm for the HD-DVD by the laser diode 106b. The laser diodes 106 can be selectively used by the laser diode driver 122. Moreover, the numeric aperture NA of the objective lens 104 is preferably changed to 0.45 for the CD, 0.6 for the DVD, and 0.65 for the HD DVD. The NA value can be optically changed based on the wavelength characteristic of a wavelength selection filter element (not shown) arranged on the optical axis, and each wavelength is subjected to optimum spherical aberration correction by a diffraction grating (not shown) provided on the laser diode side surface of the objective lens 104.

Referring to FIG. 2, the laser beam of the wavelength of 405 nm emitted from the laser diode is shown by a solid line. The emitted laser beam is focused on the optical disc 100, and the reflected laser beam from the optical disc 100 is split by the beam splitter by 103 and received by photo-detectors 108a and 108b which are provided in a disc radial direction. Photocurrent outputs obtained from the photodetectors 108a and 108b are converted into voltage outputs by the I-V amplifiers 109 and 110, respectively. A signal which changes in accordance with the wobble of the groove is obtained through calculation by the differential amplifier 112. In this case, an output signal in accordance with a change in the light amount of laser beam reflected from recorded marks is obtained as a read signal (RF signal) through calculation by the additional amplifier 111. This RF signal is AC-coupled by an element such as a capacitor C (not shown), and transferred to the RF signal processing section 113 at the latter stage. The RF signal processing section 113 generates a binarized signal from the received RF signal to output to the RF data demodulating section 114, and calculates a performance evaluation index to output to the disc system control section 119. The RF data demodulating section 114 decodes a reproduced signal, which is binarized and synchronized with a clock signal, by a decoder circuit to generate demodulated data, and further carries out error correction to the decoded signal by an error correction circuit, and outputs the error-corrected signal to the host side (not shown) as a reproduced data signal. In the error correction circuit, for example, a PI error count is calculated. At the same time, the reproduced data signal is outputted to a data ID detecting se ction 115. The data ID detecting section 115 acquires address data embedded in the reproduced data signal based on the demodulated data signal outputted from the RF data demodulating section 114.

On the other hand, the wobble signal processing section 116 includes a band-pass filter having a pass band near a wobble frequency, a PLL (Phase Locked Loop) circuit for generating a wobble clock signal synchronous with the wobble signal, a sampling circuit which samples an output of the band-pass filter synchronous with the wobble clock signal, and a synchronizing circuit which binarizes and synchronizes an output of the sampling circuit. The wobble signal processing section 116 outputs a recording clock signal and a binarized synchronous data signal of the wobble signal. The wobble data demodulating section 117 includes an address decoder which decodes the binarized synchronous data signal outputted from the wobble signal processing section 116 to extract wobble address data (wobble ID). The wobble ID detecting section 118 detects address data corresponding to a physical sector, such as a sector number, and a track address, which are embedded in the wobble signal. The wobble signal processing section 116 operates to control the spindle rotation speed of the spindle control section 123 such that the frequency of the wobble clock signal outputted from the PLL circuit is constant. Thus, the scan speed of the laser beam can be kept at a substantially constant linear speed.

The disc system control section 119, upon recording a data signal on the optical disc, generates a data pattern based on the address data outputted from the wobble ID detecting section 118, and a data signal supplied from a host in synchronization with a recording clock signal kept to a fixed frequency. In accordance with the data pattern generated by the disc system control section 119, the optical head control section 121 controls the laser diode driver 122 to modulate the laser beam intensity emitted from the laser diode and to form the data pattern on the optical disc as the recorded mark with a constant linear density. Moreover, in response to a control signal from the disc system control section 119, control of changing the laser diode 106 is performed. The data signal is supplied from the host to the disc system control section 119 through an interface section (not shown) and is recorded on the optical disc. In addition, the disc system control section 119 according to the present invention generates a control signal based on disc identification data of the optical disc loaded in the optical disc apparatus, and controls the RF signal processing section 113 and the optical head control section 121 based on the disc identification data from a servo processing section (not shown). Further, the disc system control section 119 generates the data pattern based on the disc identification data, and controls the laser diode driver 122 via the optical head control section 121.

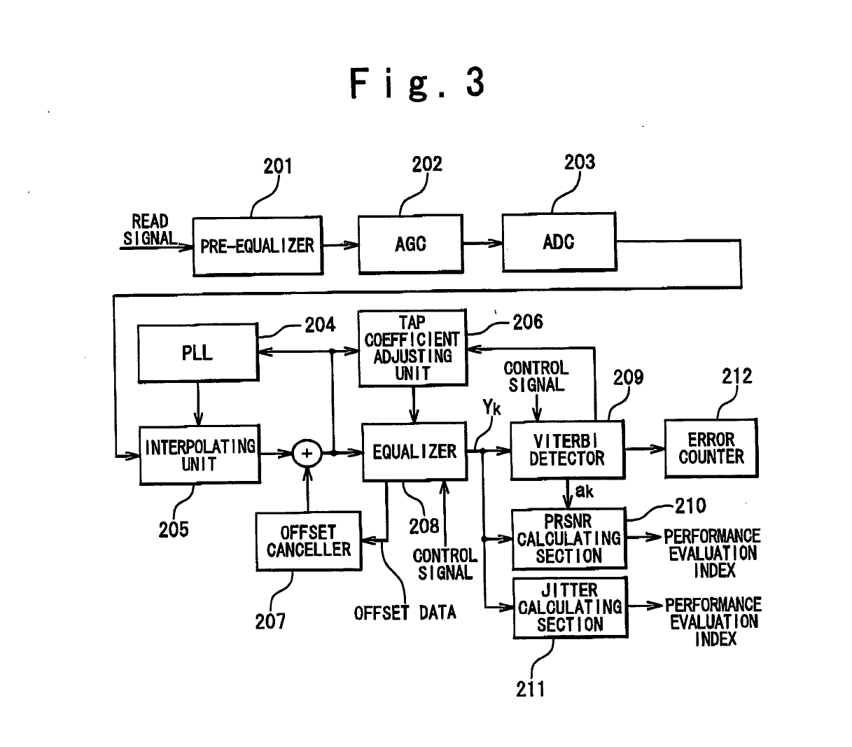

FIG. 3 is a block diagram showing the configuration of the RF signal processing section 113 according to the present invention. Referring to FIG. 3, the RF signal processing section 113 is provided with a pre-equalizer 201, an AGC (Automatic Gain Controller) circuit 202, an ADC (A/D Converter) circuit 203, a PLL (Phase Locked Loop) circuit 204 for acquiring a reproduction channel clock signal, an interpolating unit 205 which temporally interpolates data sampled by the PLL circuit 204, an equalizer 208 which adaptively adjusts predetermined frequency characteristics, a tap coefficient adjusting unit 206 which controls tap coefficients used in the equalizer 208, an offset canceller 207 which cancels an offset of an equalized signal outputted from the equalizer 208, and a Viterbi detector 209. In addition, the RF signal processing section 113 is provided with a PRSNR calculating section 210 and a jitter calculating section 211 for calculating performance evaluation indexes, and an error counter 212 which calculates an error rate to a channel. Although being omitted in the present embodiment, an SbER calculating section may be further provided which calculates SbER as one of performance evaluation indexes specified for the HD DVD.

More specifically, an RF signal as the read signal by the optical head 101 is equalized into a waveform signal having a predetermined frequency characteristic by the pre-equalizer 201. Here, for example, the pre-equalizer 201 is configured to have a seventh-order analog filter, and a high frequency characteristic is improved through boost equalization with approximately 6 dB for an HD DVD. Subsequently, the RF signal is subjected to amplitude correction to a predetermined amplitude value by the AGC circuit 202, and is subjected to 8-bit quantization by the ADC circuit 203 to be converted into a multi-value digital data signal. A clock signal of a fixed frequency from a synthesizer is used as this sample clock signal. A synchronization clock signal is extracted from the quantized digital signal by the PLL circuit 204 and transmitted to the equalizer 208. The interpolating unit 205 has a role of temporally interpolating a data signal sampled by the PLL circuit 204. Here, the equalizer 208 is an adaptive equalizer which is controlled based on tap coefficients determined in accordance with the data signal from the Viterbi detector 209. As an adaptive equalization method, for example, an MSE (mean square error) method or the like is used. The offset canceller 207 extracts offset data from the equalized signal to cancel the offset of the equalized signal. The PRSNR calculating section 210 performs calculation by using the equalized signal Yk as an output of the equalizer 208 and a Viterbi detection signal ak as an output of a Viterbi detector 209. On the other hand, the jitter calculating section 211 can sample an edge-to-edge width or a pulse width of a binarized signal for a predetermined period based on the equalized signal Yk, and calculate a variance σ2 as a frequency distribution for a detection window. The error counter 212 calculates the error rate of the channel. The PI error set in the RF data demodulating section 114 is a byte error, but a channel bit error of a record data sequence before modulation, which is previously recognized, can be outputted. The equalizer 208 can be formed by using a transversal filter or the like. For example, a transversal filter having seven half-fixed tap coefficients (C0, C1, . . . , C6) may be used, or the tap coefficients may be changed adaptively to improve the resolution of a read signal.

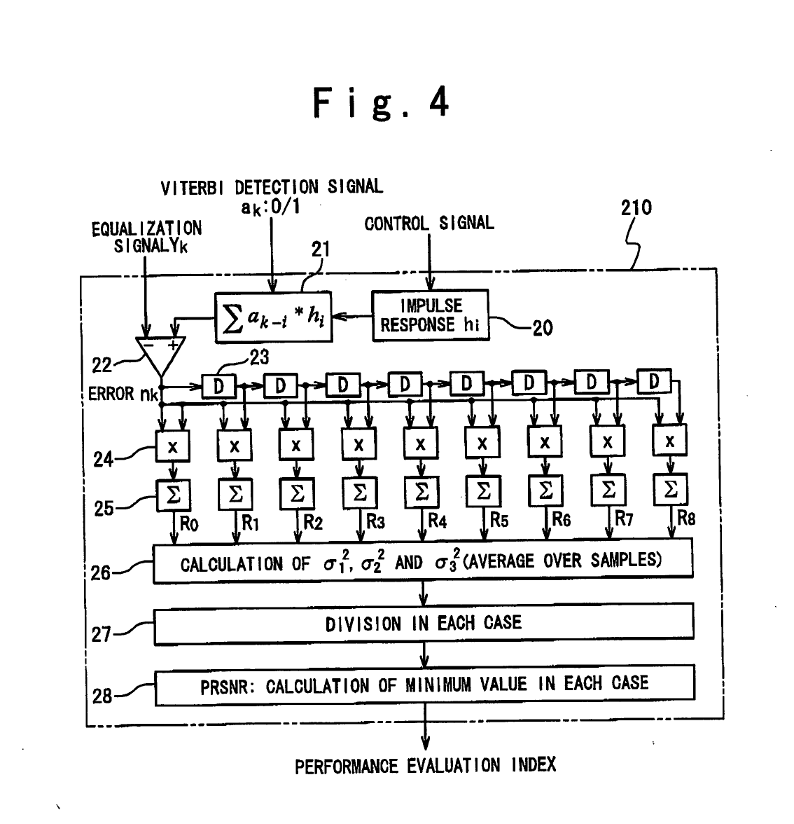

FIG. 4 is a block diagram of the PRSNR calculating section 210 according to the first embodiment of the present invention. The PRSNR calculating section 210 calculates PRSNR corresponding to identification data of the optical disc (standards for the optical disc) based on a control signal supplied from the disc system control section 119. Referring to FIG. 4, the PRSNR calculating section 210 includes an impulse response calculating section 20 which outputs an impulse response hi (where i is from 0 to a constraint length −1) used as a target based on a control signal supplied from the disc system control section 109, a target signal waveform calculating section 21 which calculates a data sequence Σak−i×hi of an ideal waveform signal from the Viterbi detection signal ak supplied from the Viterbi detector 209 as well as the impulse response hi used as a target, and a comparing section 22 which calculates an error signal nk from the PR equalized signal Yk, in which a delay time corresponding to the Viterbi detector 209 has been adjusted, and the data sequence Σak−i×hi of the ideal waveform signal. In addition, the PRSNR calculating section 210 further includes a delay circuit 23, a multiplying circuit 24, and an adding circuit 25, and outputs a correlation matrix Ri (where i is from 0 to a constraint length −1) based on the error signal nk. Further, the PRSNR calculating section 210 further includes a noise variance calculating section 26, a dividing circuit 27, and a PRSNR output section 28, which are all provided to output the PRSNR by using the correlation matrix Ri. The noise variance calculating section 26 uses the outputted correlation matrix Ri to calculate a noise variance σ2 for a case where an error is likely to occur in data identification. The dividing circuit 27 calculates SNR (d/σ2) from the ratio of the Euclidean distance d to the noise variance σ2 for a respective case. The PRSNR output section 28 outputs the smallest SNR in the respective cases as the PRSNR. With such a configuration, the PRSNR calculating section 210 uses the error signal nk calculated from the PR equalized signal Yk and the data sequence Σak−i×hi of the ideal waveform signal to calculate a noise component of each time (timing of each clock signal). Thus, the PRSNR calculating section 210 can easily calculate expected values of various types of noise. The data sequence of the ideal waveform signal may be calculated by using a data sequence from the Viterbi decoder 209 in case of a system having the Viterbi decoder, or by using a signal whose data sequence is previously known (set signal) in case of a system not having the Viterbi decoder.

Here, it is preferable that cases are grouped into three error cases with short Euclidian distances as cases where error is likely to occur in data identification. The three cases include a bit shift error, a 2T error, and a 2T continuous error. It should be noted that in order to further increase the accuracy, the PRSNR may be calculated by grouping error patterns into as many cases as possible, although the number of cases is here limited to three only in terms of the circuit size and the high speed processing. Moreover, the PRSNR itself is specified for the HD-DVD, and specified by the PRML method for ETM modulation, especially by the PR (12221) characteristic. Thus, it can be directly applied in case of a modulation code with an encoding ratio of 2/3 and a minimum run length of 1, as is the case with 1-7 modulation. Therefore, it is applicable to 1-7modulation adopting 2 bits/3 bits conversion, 2/3 modulation represented by 1-7 PP, 4/6 modulation considered as bit width extension, 8/12 modulation represented by ETM (Eight to Twelve Modulation), and the like. In case of a method with a minimum run length d being not 1, as well as in case of a modulation and demodulation method being different from that for the HD DVD, the error generation frequency is different, and thus the cases are not limited to these cases.

The Viterbi detector 209 according to the present invention changes the PR characteristics to be used in accordance with the type of the optical disc 100, and has a plurality of Viterbi decoders which apply their respective PR characteristics to execute a Viterbi decoding. More specifically, for the optical disc 100 for an HD DVD rewritable format, the PR (12221) characteristic (here, a=1, b=c=2) as a general equation of the PR (abcba) characteristic is applied, and the Viterbi decoder 209 associated therewith performs the Viterbi decoding. In this case, the impulse response calculating section 20 outputs an ideal impulse response, i.e., (a, b, b, b, a)=(1, 2, 2, 2, 1) For the optical discs 100, such as HD DVD-ROM/-R, with a relatively gentle density, the PR (1221) characteristic (here, a=1, b=2) as the general equation of the PR (abba) characteristic is applied, and the Viterbi decoder attached thereto performs the Viterbi decoding. In this case, an ideal impulse response, i.e., (abba)=(1, 2, 2, 1) is outputted to an impulse response calculating section 4. This PR (1221) characteristic has a characteristic directly applicable to the DVD, and if in addition to this characteristic, the PR characteristics such as a PR (1331), a PR (1551), a PR (2332), and a PR (3443), as well as Viterbi decoder associated therewith are provided, the Viterbi decoding can be performed in accordance with each of the PR characteristic. On the other hand, to achieve circuit downsizing and high speed recording and reproduction while more or less sacrificing the reproduction performance, the PR (abc) characteristic with the constraint length of 3 also has an applicable characteristic. For example, the PR characteristics such as a PR (111), and a PR (121), as well as the Viterbi decoder associated therewith may also be further provided. As described above, the RF signal processing section 113 according to the present invention previously prepares a plurality of performance evaluation index calculation methods. Therefore, the performance evaluation index calculation method for an inserted optical disc can be selected for processing, so that an optimum performance evaluation index for the optical disc standards can be calculated.

A reference for selecting the performance evaluation index calculation method for the optical disc 100 desirably ensures the optimum performance. However, standards of a CD and a DVD are not premised on the PRML method, thereby leaving limited choice. Waveform equalization methods are also simple methods, and most of them are realized by, for example, a PR (1) method represented by PR (a). Practically, high-frequency emphasis is the basis for improvement in the resolution for reading the shortest mark/space. Too broad band of a reproduction channel increases noise, resulting in deteriorated reproduction performance. Therefore, a LPF (Low Path Filter) is used to impose a limitation on the high frequency band. That is, in case of the optical disc 100 with standards not premised on the PRML, the RF signal processing section 113 binarizes this signal waveform-equalized by a comparator while following it at the DC level, generates a PLL clock signal from this binarized signal, and calculates a jitter value, which is then treated as a performance evaluation index.

For a high-density optical disc using the PRML, especially the HD DVD, there are a plurality of possible performance evaluation indexes. For example, a System Lead-In area arranged on the disc inner circumference side has only a half of a data area, and is equivalent to a density for a DVD. Therefore, the resolution is extremely high, and thus the jitter value can be treated as the performance evaluation index. The data area, except for an HD DVD rewritable type (with a single layer capacity of 20 GB), has the capacity of 15 GB per single layer, and the density is relatively more gentle than that of a HD DVD rewritable type. Therefore, the reproduction resolution is high, so that a sufficient effect can be expected even in the PR characteristic with the constraint length of 4 in case of PR (1221), or the constraint length PR of 3 in case of PR (121) in the PRML method. Thus, the performance evaluation index of the PRSNR exists as long as the PR characteristics can be assumed.

Although the DVD does not require the PRML according to its standards, products adopting the PRML as an optical disc drive have come into market for various reasons, such as reproduction margin insufficiency involved in the high multiple speed recording, use of a low-price and bad disc, and adjustment cost reduction. That is, for the optical disc 100 premised on the PRML, the PR characteristic having the constraint lengthof approximately 3 or 4 is suitable in case of a system employing the numeric aperture NA of the objective lens of 0.6 and an laser diode with the wavelength of 650 nm. Thus, for example, PR (121), PR (1221), and PR (3443) are preferable as the PR characteristic.

Next, identification processing of the optical disc 100 performed in the optical disc apparatus according to the present invention will be described. At the stage at which the optical disc 100 is inserted, the laser diode on the DVD side is turned on to emit a laser beam, and the objective lens 104 mounted on the objective lens actuator 102 is scanned at a predetermined speed along the optical axis under the feed forward control by a servo circuit (not shown). Thus, the disc identification is carried out based on the time difference between the reflected laser beam from the disc substrate surface which interval is detected at zero crossing of a focus S-curve on the DVD side. The signal of this detected time difference is transmitted to the disc system control section 119 as the identification data, so that the disc system control section 119 can identify the type of the optical disc 100. For example, the disc system control section 119 estimates the thickness of the disc substrate based on the time difference of this detected signal, and identifies the optical disc 100 from the thickness. As one example, the time difference in a signal detected from the CD disc substrate is approximately twice the time difference in a signal detected from the DVD disc substrate. Thus, the identification of the type of the optical disc 100 is possible. Of course, whether the disc is a DVD disc may be identified based on results of detection performed by a detection system using the laser beam having the wavelength for the CD, although this method is known to result in low detection sensitivity. In addition, distinction between a single layer type and a double layer type of a DVD can be also made based on the time difference of a detected signal in the same manner.

However, the DVD and the HD DVD has the same disc substrate thickness, i.e., 0.6 mm. Thus, the DVD and the HD DVD cannot be identified from each other. For this reason, it is possible to achieve the identification of the two types of discs by reading identification data previously recorded in a predetermined area of the optical disc. For example, the DVD and the HD DVD can be identified by reading a BCA (Burst Cutting Area) provided at the disc innermost circumference. The BCA is largely different between the DVD and the HD DVD in characteristic. In this case, the disc system control section 119 acquires as the identification data, an identifier recorded on the BCA. The BCA is not essential for the DVD, and thus the BCA is riot provided in most current DVDs, while the BCA is essential for the HD DVD according to its standards. It should be noted that in case of a double-layer type of HD DVD disc, the BCA is provided at the second layer which is located on the side remote from the objective lens 104. In this case, because of difficulty in optically transmitting the laser beam of the wavelength for the DVD, the identifier can be read for identification by a detection system which uses a laser beam of the laser diode wavelength for the HD DVD. Upon reading the BCA, tracking in the disc radial direction is not required, thus allowing the disc identification in short time.

As another possible disc identification method, the DVD and the HD DVD has a System Lead-In area provided on the inner circumference side of the optical disc 100. On the System Lead-In area, data or the optical disc 100 is emboss-recorded, and this recording data is read to acquire the identifier for identification while the disc is tracked in the disc radial direction. With this method, the identifier can be read with the emitted laser beam, for optical discs of almost the same recording density regardless of the DVD or the MD DVD. Thus, the identification of the optical disc 100 can be carried out. Moreover, if there is recorded data, it is also possible to use a difference in a modulation and demodulation method, such as whether or not identification data of the recorded data can be read.

Further, as still another possible disc identification method, a method may be adopted in which the user who knows the type of the inserted optical disc 100 previously transmits the identification data to the optical disc apparatus. For example, by using application software on the host computer, previously prepared identification data such as a selection switch is transmitted as a command parameter to the optical disc apparatus. The disc selection switch may be provided in the simple form of three CD, DVD, and HD DVD buttons previously prepared and mounted as a graphical user interface (GUI). Based on a signal transmitted as the command parameter, selection is made from among a plurality of performance evaluation index calculation methods previously included in the optical disc apparatus. Instead of the disc selection switch on the application software, a disc selection switch previously prepared in the form of hardware provided in the optical disc apparatus may be operated by the user to previously transmit the identification data to the optical disc apparatus. More specifically, a plurality of disc selection switches may be provided in correspondence with a plurality of disc types in the DVD. However, in this case, a risk of an increase in selection error arises, resulting in an increase in the start-up time of the optical disc apparatus. Therefore, the number of switches is optionally specified.

Based on the detected identification data as described above, a control signal is transmitted from the disc system control section 119 to the RF signal processing section 113, which calculates an optimum performance evaluation index for the optical disc 100 in response to this control signal, and then performs evaluation or adjustment of the optical disc 100 by using this index.

Next, an operation of the optical disc apparatus will be described below. With the configuration described above, the optical disc apparatus according to the present invention calculates a performance evaluation index corresponding to the type of an inserted optical disc (standards), and controls rotation of the optical disc 100 or the optical head 101 based on this performance evaluation index, to execute an operation of the optical disc apparatus such as the evaluation and adjustment of the optical disc 100. Hereinafter, the operation performed in evaluation and adjustment of the optical disc 100 in the optical disc apparatus according to the present invention will be described.

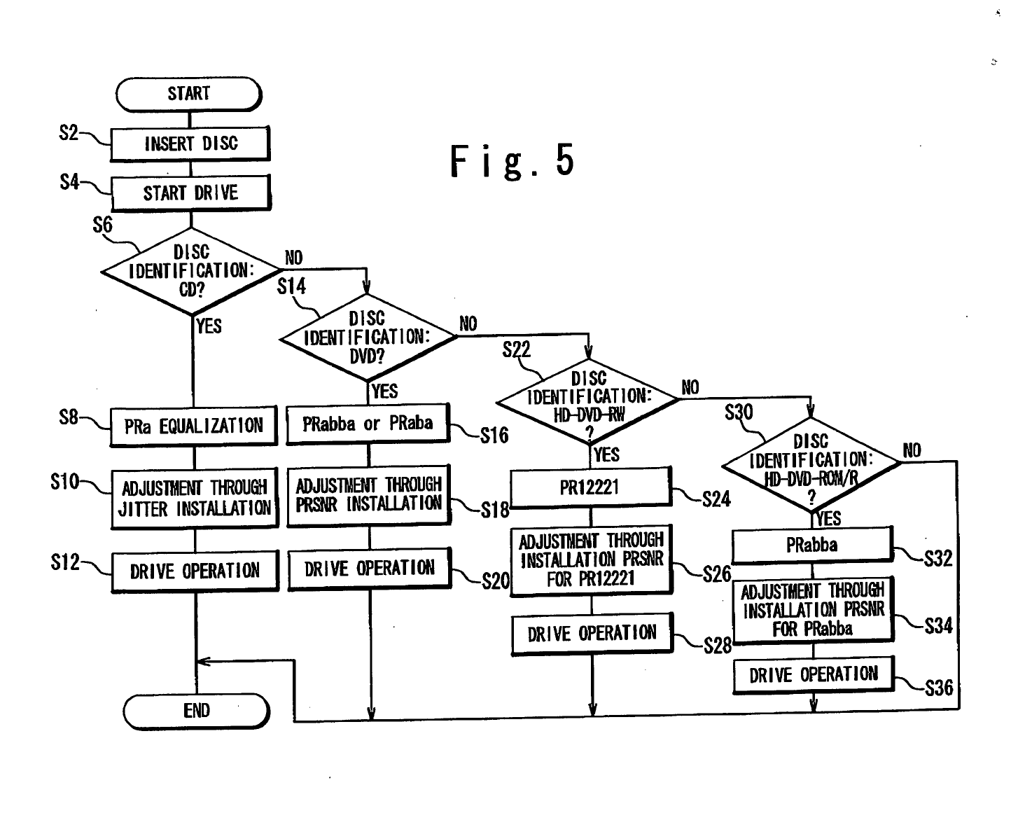

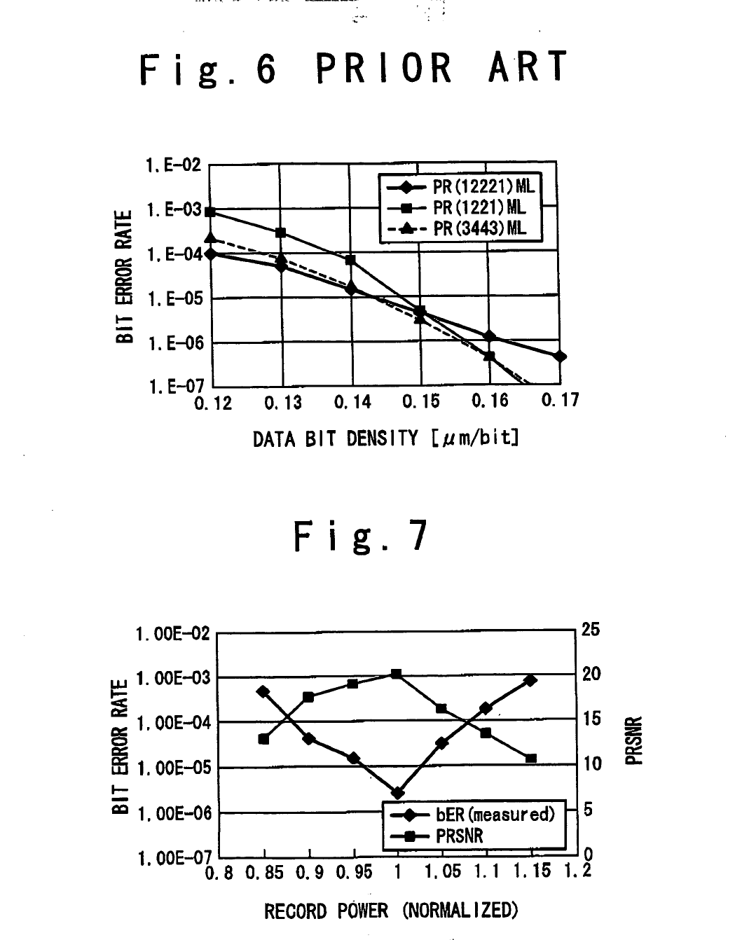

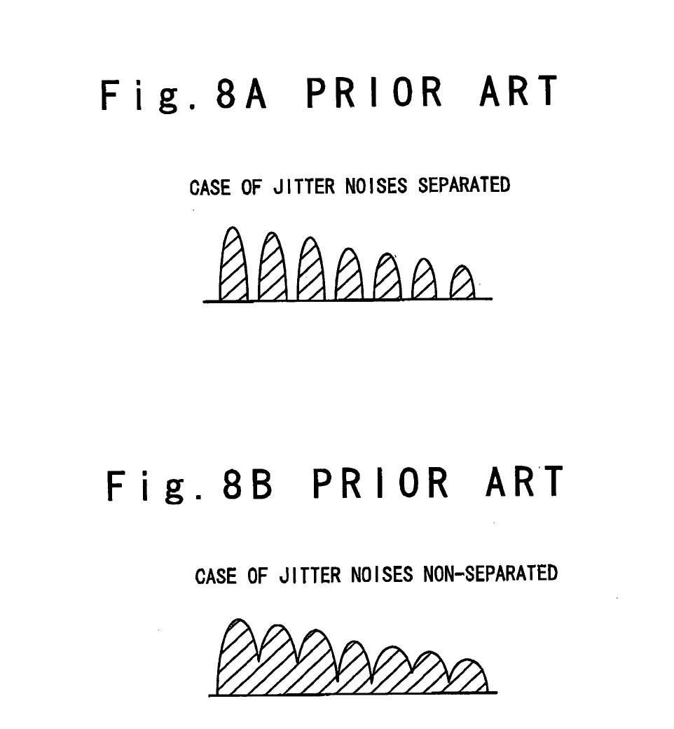

FIG. 5 is an example of a flowchart showing the operation of processing from insertion of the optical disc 100 to drive of a function operation in the optical disc apparatus according to the present invention. Referring to FIG. 5, the optical disc 100 is inserted in the optical disc apparatus according to the present invention (step S2), and as a drive starting operation, the spindle motor 124 is driven until reaching a predetermined rotation speed, and a predetermined laser diode 106 is driven to emit a laser beam (step S4). Here, the predetermined laser diode 106 is the laser diode 106b with the wavelength of 405 nm, which is previously determined depending on the disc identification method. Following the laser beam emission, the operation of identifying the disc type is started (steps S6, S14, S22, and S30). Here, the identification operation from the step S6 to the step S30 are executed in order, although not limited to this order. Moreover, all the steps of identification operation may be executed at the same time.

Next, a reproduction equalization method is selected for the optical disc 100 identified by the identification operations in steps S6 to S30 (steps S8, S16, S24, and S32). When the optical disc 100 is identified, a parameter related to reproduction or recording and the performance evaluation index used for the apparatus adjustment are calculated in accordance with the type of the identified optical disc 100 (steps S8, S16, S24, and S32). Moreover, apparatus adjustment is executed based on the performance evaluation index in accordance with the type of the identified optical disc (steps S10, S28, S26, and S34), and drive function operations such as data reproduction and recording to the optical disc 100 are executed (steps S12, S20, S28, and S36).

More specifically, if the optical disc 100 is identified as the CD (YES in step S6), a reproduced data signal is generated by switching to the PR (a) equalization, and a jitter calculated by the jitter calculating section 211 is outputted as a performance evaluation index (step 8). The disc system control section 119 controls the optical head control section 121 to execute adjustment of recording condition or reproduction condition by the optical head 101 based on the jitter set and selected as the performance evaluation index (step S10). Upon completion of the adjustment, a data signal is reproduced from the CD, or a drive operation of recording a data signal on the CD is executed (step S12).

If the optical disc 100 is identified as the DVD (YES in step S14), a reproduced data signal is generated by applying the PR (abba) equalization or the P4R (aba) equalization for the PRML method, and PRSNR calculated by the PRSNR calculating section 210 is outputted as the performance evaluation index (step S16). The disc system control section 119 controls the optical head control section 121 to execute the adjustment of the recording condition or the reproduction condition by the optical head 101 based on a PRSNR set and selected as the performance evaluation index (step S18). Upon completion of the adjustment, a data signal is reproduced from the DVD, or the drive operation of recording the data signal on the DVD is executed (step S20).

If the optical disc 100 is identified as the HD DVD rewritable type (YES in step S22), a reproduced data signal is generated by applying the PR (12221) equalization for the PRML method, the PRSNR for the PR (12221) calculated by the PRSNR calculating section 210 is outputted as the performance evaluation index (step S24). The disc system control section 119 controls the optical head control section 121 to execute adjustment of the recording condition or the reproduction condition by the optical head 101 based on the PRSNR for the PR (12221) set and selected as the performance evaluation index (step S26). Upon completion of the adjustment, a data signal is reproduced from the HD DVD-RW, or the drive operation of recording the data signal on the HD DVD-RW is executed (step S28).

If the optical disc 100 is identified as an HD DVD-ROM/R (YES in step S30), a reproduced data signal is generated by applying the PR (abba) equalization for the PRML method, and the PRSNR for the PR (abba) calculated by the PRSNR calculating section 210 is outputted as the performance evaluation index (step S32). The disc system control section 119 controls the optical head control section 121 to execute adjustment of a recording condition or a reproduction condition by the optical head 101 based on the PRSNR for the PR (abba) supplied as the performance evaluation index (step S34). Upon completion of the adjustment, a data signal is reproduced from the HD DVD-ROM, or the drive operation of recording the data signal to the HD DVD-R is executed (step S36). The “PRSNR” is the term of a performance evaluation index currently defined for the HD DVD, and it is presumed that the PR (12221) characteristic is applied. The use of the term “PRSNR” for other PR characteristics is not appropriate. Therefore, in the present specification, the terms the “PRSNR for the PR (abcba)” and the “PRSNR for the PR (abc)” are used.

An example of the flowchart showing the operation of processing from the insertion of the optical disc 100 to a drive function operation performed in the optical disc apparatus according to the present invention has been indicated above. However, the PR method in each disc is just one example. The method may be changed considering apparatus cost or easiness in designing. However, due to a difference among the PR methods in the adjustment accuracy and correlation with the bit error, an index of an optimum recommended method for each optical disc in the present embodiment will be described as one example.

[Disc Identification Processing]

Various methods are proposed for the disc identification operation at steps S6, S14, S22, and S30, and there is a method of performing measurement by using a focus S curve based on a signal from the disc, the RF signal amplitude, to identify the CD, the DVD, and another disk, as described above. This method is just one example and the method is not necessarily limited to those described above. The disc identification is not necessarily complete with broadly classified disc identification results (major classification into the CD, the DVD, and the HD DVD), because there are included many identifiers for identifying whether the disc is a single-layered or multilayered (up to double layered discs have been commercialized at present), and whether the disc is a recording-type or a read-only type. For the CD, there is no multi-layered disk. Thus, only distinction on whether the disc is a recording-type or a read-only type is required, although even this distinction is not required as far as the example of the present invention is concerned. In case of the CD, the apparatus adjustment is made with the jitter index. Thus, it is sufficient to provide Pra, for example, a filter for high-frequency emphasis in a PR1 method. On the other hand, if the disc is not the CD, that is, in case of identification of whether or not the disc is the DVD, guidelines are provided through standardization. However, as the optical disc apparatus, identification can be also achieved by reproducing disc data recorded on the System Lead-IN area arranged at the disc inner circumference. If the disc is the HD DVD, the identification can be also achieved by reproducing the BCA which is required to be arranged in the disc.

[Performance Evaluation Index Calculation Processing]

Next, a detailed example of calculating the PRSNR outputted as the performance evaluation index will be described. For example, to obtain the PRSNR for the PR12221, the following calculation is carried out. Here, cases indicate cases of the bit shift, 2T error, and 2T continuous error, with the Euclidian distances being represented as numerical values d1, d2, and d3, respectively.
Case 1:d1=14 (1)
Case 2:d2=12 (2)
Case 3:d3=12 (3)

In addition, a noise dispersion in each case is expressed by the following equation:
Case 1:σ₁²=R₀+(12R₁+8R₂+4R₃+R₄)/7 (4)
Case 2:σ₂²=R0+(8R1+R2−4R3−6R4−4R5−R6)/6 (5)
Case 3:σ₃²=R₀+(8R₁+2R₂+R₄+4R₅+6R₆+4R₇+R₈)/6 (6)
where Rᵢ=E[nₖ, nₖ+i] (7)

As indicated in the following equation (8), the smallest one of the ratios in the respective cases (d/σ2) is selected, and the PRSNR for the PR12221 can be calculated:
z₂=min(14/σ₁², 12/σ₂², 12/σ₃²) (8).
On the other hand, to obtain the PRSNR for the PR1221, the following calculation is carried out in the same manner. Cases indicate cases of the bit shift, 2T error, and 2T continuous error, with the Euclidean distances being represented as numerical values d1, d2, and d3, respectively:
Case 1:d1=10 (9)
Case 2:d2=12 (10)
Case 3:d3=14 (11)
In addition, the noise dispersion in each of the cases can be expressed by the following equation:
Case 1:σ₁²=R₀+(8R₁+4R₂+R₃)/5 (12)
Case 2:σ₂²=R₀+(7R₁−2R₂−6R₃−4R₄−R₅)/6 (13)
Case 3:σ₃²=R₀+(7R₁−4R₂−5R₃+2R₄+6R₅+4R₆+R₇)/7 (14)
where Rᵢ=E[nₖ, nₖ+i] (15).

As shown in the following equation (16), the smallest one of the ratios (d/σ2) in the respective cases can be selected to calculate the PRSNR for the PR1221:
z₂=min(10/σ₁², 12/σ₂², 14/σ₃²) (16)

Through the method described above, the optical disc apparatus according to the present invention can execute various PRSNR calculations in accordance with a previously assumed kind of optical disc (here, the CD, the DVD, or the HD DVD). In this case, a problem arises when the optical disc apparatus encounters discomformity with the optimum performance evaluation index in accordance with the type of the optical disc inserted and identified. Thus, in order to use the waveform equalization method and the binarization method corresponding to the performance evaluation index, the configuration of the equalizer 208 and the Viterbi detector 209 installed in the RF signal processing section 113 and parameter setting are changed in response to a control signal outputted from the disc system control section 119. More specifically, the equalizer 208 configured to have the same tap count as that used in the selected performance evaluation index calculation method, for example, the PRSNR calculation for the PR12221. Also, a Viterbi decoder as a binarizing means of the 9 values 10 states is selected from the Viterbi detector 209. Thus, the discomformity of the PRSNR calculation with performance evaluation can be avoided. Moreover, in the RF signal processing section 113 as a signal detection circuit in the optical disc apparatus, the equalizing circuit 208 and the Viterbi detector 209 are provided not only for the PRSNR calculation, but they have many sections that can be used as signals. Therefore, they can be specified in conjunction with each other. For example, the PR method specified by the PRSNR calculation is set as the equalization method. At the same time, a Viterbi detection method specified and used by the PRSNR calculation is also used for signal detection. Therefore, the equalizer 208 performing PR equalization and the Viterbi detector 209 which are provided in the RF signal aprocessing section 113 arelalso used for reproduction of data from a recorded mark sequence. Thus, the circuits are not configured to perform only the PRSNR and SbER calculations, but also to be used in conjunction with each other, the circuit size can be suppressed to the minimum size.

Moreover, it is needless to say that calculation can be performed in accordance with various PR characteristics such as the PRSNR for the PR (aba), and the PRSNR for the PR (abba). Moreover, unlike the PR (abba), calculation can be practically carried out (where, a, b, c, and d are positive integers) even for an impulse response which is not symmetrical, for example, an asymmetrical impulse response like the PR (abcd).

On the other hand, a modification of the present invention will be described. It is actually adequate to select the PR characteristic, considering a high speed clock operation for high-speed recording and reproduction in a practicable circuit size and power consumption in addition to the reproduction performance. Calculation can be also performed by providing a DSP and flexibly programming. In this case, however, it is inappropriate to perform calculation in actual time. Therefore, it is desirable that the PRSNR calculating section 210 is a calculating section configured with general-purpose hard logic. For example, in case of the PRSNR, configuration is adopted such that the coefficients of the Euclidean distances numerically represented in the three cases and each coefficient of noise dispersion (signed) are previously set in registers. Thus, the PRSNR calculation method can be achieved in a versatile manner. In this case, there are various possible PRML methods for each possible constraint length, but the circuit size is specified depending on whether or not coefficients up to a higher order can be taken. The current maximum side is 9 taps corresponding to the configuration of the PR (12221) as described above. Accordingly, it is preferable to prepare a register configuration in accordance therewith.

[Apparatus Adjustment Processing]

FIG. 7 is an example of measurement showing the relationship between the recording power and the bit error rate including the bER and the PRSNR. The optical disc 100 used for this measurement is a phase-change type, overwritable recording medium. The horizontal axis indicates the recording power. This corresponds to a peak power value obtained by adding the erasing power under a predetermined ratio. When the recording power is low, the PRSNR remains low since the recorded mark cannot be formed. When overwriting is carried out by increasing the recording power, the PRSNR becomes a maximum value at a certain value of the power. Thus, it could be understood that the PRSNR deteriorates if overwriting is carried out with an excessive-recording power. At that time, it could be also understood that the bit error rate bER is a minimum value when the PRSNR is high. From the facts described above, the recording power can be adjusted with the PRSNR as the index.

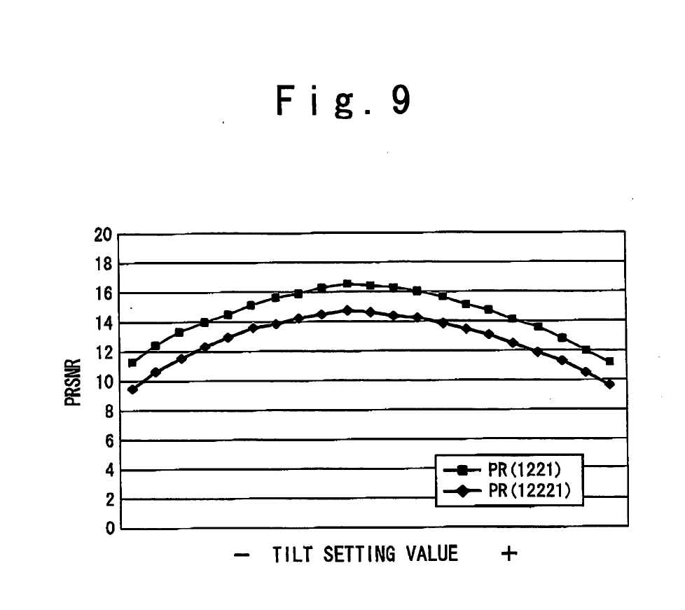

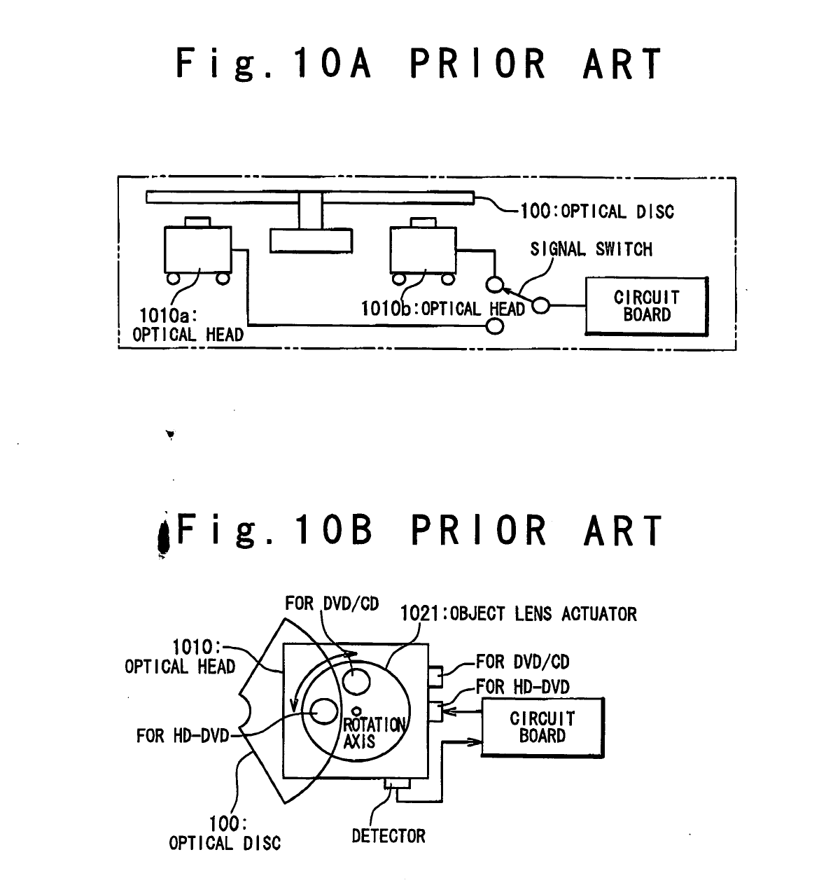

Moreover, the tilt adjustment can be carried out by forcibly swinging the relative tilt angle between the optical disc 100 and the objective lens 104 for the objective lens actuator 102 by a tilt mechanism (not shown). If the relative tilt angle is large, the PRSNR of the recorded mark deteriorates under the influence of coma aberration. If there is an adjacent mark, the deterioration is of course even more remarkable due to a reproduction cross talk. Therefore, if the tilt angle is relatively swung, there exists a maximum point of a PRSNR value. FIG. 9 is an example of experimental results of tilt correction to two types of PRSNRs for the HD DVD-ROM. Referring to FIG. 9, it could be understood that the maximum point of the PRSNR value exists depending on the tilt angle. This maximum point is handled as a tilt optimum point, and the tilt adjustment can be implemented.

Further, similarly in a defocusing adjustment, a focus offset can be forcibly provided to find the maximum point of the PPSNR value. In detrack adjustment, offset addition can be of course forcibly provided to radial tracking to find the maximum point of the PRSNR value. In addition, in recording strategy adjustment, for example, the recording pulse width can be forcibly changed from a predetermined value to find the maximum point of the PRSNR value. Other than those described above, the maximum point of the PRSNR value can be similarly found for apparatus adjustment items which influence the PRSNR value. Thus, methods of finding the maximum point of the PRSNR value are not limited to those described above.

Therefore, as in the present invention, an optical disc apparatus with a favorable accuracy and a broad margin can be achieved by previously selecting an optimum PRML and optimum PRSNR calculation depending on the circuit configuration for each inserted optical disc 100. Similarly, depending on the optical disc 100 inserted (for example, the CD), it is of course effective to select the jitter calculation to achieve such the optical disc apparatus.

To carry out apparatus adjustment with the bit error rate bER, the apparatus is required to previously know a pattern to be recorded. However, in case of the PRSNR, the apparatus is not required to previously recognize the record pattern in order to extract a difference of a Viterbi output from the ideal waveform by using the RF signal. Therefore, it is preferable that the PRSNR be used for the apparatus adjustment and evaluation with the same concept common to the jitter calculation.

In the above embodiment, the PR characteristics are generalized by the PR (abba), and the PR (abcba), but the constraint length is not limited thereto. The apparatus may be implemented with PR (aa) with the constraint length of 2. Typically, the circuit size increases with an increase in the constraint length. Moreover, a higher speed operation becomes more difficult in accordance with the increase in the circuit size. As a practical solution, the constraint length is limited up to 5. However, due to drastic advance in the LSI process technology, the constraint length of 6 or more is also possible, and the same idea is applied to this case. The detailed example of configuration of the RF signal processing section has been described above, but the sequence of functions carried out in the flow of RF signal processing is basically not limited, including the equalizer 208.

Moreover, at present, a twin disc has been standardized which is a double layer disc formed by adhering optical discs of two different types to allow access thereto from one side. The present embodiment has been described by referring as one example to the optical disc apparatus for a single-type (a single-layer or a double-layer type) optical disc 100. The optical disc can also be provided for such a twin disc format. For example, a twin disc is known which has a DVD-ROM in an LO layer and an HD DVD-ROM in an L1 layer from the incidence surface side. Identification of this disc is carried out by reading the BCA on the L1 side. To read data from the DVD-ROM based on results of the identification of this optical disc, the PRSNR calculation method for the PR (abba), for example, for the PR (1221) can be selected. Thus, disc reproduction adjustment such as the tilt adjustment, and defocusing adjustment can be carried out optimally and with favorable accuracy with the performance evaluation index suitable for a multi double-layer optical disc 100.

Moreover, the disc system control section 119 may be configured to estimate recommended optical conditions, i.e., the light source wavelength λ and the objective lens numerical aperture NA based on identification data obtained from the inserted optical disc 100, to identify the optical disc 100 based on these optical conditions, and then to output a control signal to the RF signal-processing section 113 and the optical head control section 121. More specifically, the disc system control section 119 estimates the recommended optical conditions, i.e., the light source wavelength λ and the objective lens numerical aperture NA based on data read from a predetermined area, for example, the SYSTEM LEAD-IN area of the inserted optical disc 100. For discs belonging to the DVD family such as DVD, and HD DVD, for example, those with the format type recorded therein are used. For discs not belonging to the DVD family, for example, discs belonging to the CD family, if the substrate thickness of the CD can be confirmed from the identification data from the focus S curve as described above, the objective lens numerical aperture NA of 0.45 and the source wavelength λ of 780 nm can be both obtained as the recommended optical conditions from data previously recorded in a ROM region in the disc system control section 119. Similarly, from identification data, numerical values of the wavelength of 650 nm and the numerical aperture NA of 0.60 are obtained for the DVD, and numerical values of the wavelength of 405 nm and the numerical aperture NA of 0.65 are obtained for the HD DVD. At that time, the same is applied to a case where data calculated from the obtained numerical values, i.e., λ/NA is previously stored. This value is 1.73 μm for the CD, 1.08 μm for the DVD, and 0.62 μm for the HD DVD. A numerical value such as rim intensity may be of course interpreted similarly, in which case conversion is of course required.

This λ/NA denotes a focusing characteristic provided by the objective lens, and is an index which is used to denote a focused beam diameter by multiplying it with a predetermined coefficient. Here, the coefficient is just indicated as 1. With a numerical value limited to this λ/NA value, a performance evaluation index to be used is selected. For example, in case of a CD, 0.45 is a recommended numerical aperture NA, but a value up to approximately 0.55 is applicable in terms of optical aberration. In case of the DVD, 0.60 is a recommended numerical aperture NA, but a value up to approximately 0.70 is applicable in terms of optical aberration. In case of the HD DVD, 0.65 is a recommended numerical aperture NA, but values up to approximately 0.68 is applicable in terms of optical aberration. A PRML method for a multiple value and multiple state is required since the recording density is higher than the focusing characteristic. Thus, a jitter calculation method is selected when the λ/NA is larger than 1.4 μm, a performance evaluation index calculation method with the constraint length of 3 through 4 is selected when the λ/NA is larger than 0.9 μm but equal to or smaller than 1.4 μm. A performance evaluation index calculation method with the constraint length of 4 through 5 is selected when the λ/NA is smaller than 0.9 μm. At this point, there is specifically PRSNR or SbER as a performance evaluation index calculation method. However, it is better to select the PRSNR to perform calculation in real time. As described above, an optimum performance evaluation index for the inserted optical disc 100 can be set and selected. Thus, effect is obtained that the accuracy in apparatus adjustment is improved.

As described above, the optical disc apparatus according to the present invention selects an optimum calculation from among performance evaluation index calculations previously prepared based on identification data for identifying the type (format) of the inserted optical disc 100. Moreover, by using the performance evaluation index calculated by the selected calculation, adjustment for optimizing a recording or a reproduction condition can be carried out. In the present embodiment, one of selectable performance evaluation indexes is the PRSNR, and the optimum performance evaluation index can be calculated by selecting and changing the configuration and type of the PRSNR calculating section 210 in accordance with the type of the optical disc 100, so that adjustment operation can be carried out based on this performance evaluation index. Further, the jitter, the SbER, the PI error may be used as the performance evaluation index. As described above, the optical disc apparatus according to the present invention is compatible with a multi-disc format assuming that various standardized discs are to be inserted, and can select an optimum performance evaluation index for each standardized disc. Thus, when the PRSNR specified in the written standards is used as an index for adjusting a tilt characteristic, a defocusing characteristic, and optimum power adjustment, especially for HD DVD-ROM/R, a correlation with the error rate can be set optimally. Thus, the accuracy in apparatus adjustment can be improved. In addition, this contributes to the reliability in disc compatibility and reduction in the apparatus adjustment time.

Further, a performance evaluation index is calculated based on an RF signal read out by the optical head 101. Thus, an optimum reproduction performance evaluation index for the inserted optical disc 100 can be provided. Consequently, an improvement in the reproduction performance of the optical disc apparatus can be expected. Therefore, in the optical disc apparatus according to the present invention, an optimum adjustment can be reliably achieved for the multi-disc format disc, and construction of an optical disc system with a high reliability is possible.

The embodiments of the present invention have been described in detail above, but detailed configuration is not limited to the embodiments described above. Thus, modifications within the range not deviating from the spirit of the present invention can be included in the present invention. In the above embodiments, the methods and configuration of selecting a performance evaluation index calculation method for the inserted optical disc based on the disc identification data have been described.

Alternatively, a method may be in which, instead of selection, the resolution or an impulse response is obtained through measurement to determine the PRML method and then the performance evaluation index such as the PRSNR in accordance with the PRML method is obtained or selected. In the above, an optical disc has been described while focusing on the CD, the DVD, and the HD DVD as the optical disc 100. Thus, this can contribute to achieving larger capacity of various kinds of optical discs such as magnetooptical discs of different recording formats.

According to evaluation and adjustment methods in an optical disc apparatus, and the optical disc apparatus of the present invention, various standardized optical discs can be adjusted with favorable accuracy. Moreover, a reproduced signal of favorable quality can be obtained from the vacious standardized discs. Further, the reliability in compatibility with the various standardized discs can be improved. Furthermore, the time required for adjusting an optical parameter for an optical disc can be reduced.

What is claimed is:

1. An operation method of an optical disc apparatus in which an optical disc is loaded, comprising:
loading an optical disc in said optical disc apparatus; and
evaluating said optical disc apparatus based on a performance evaluation index for the loaded optical disc,
wherein said evaluating comprises:
acquiring an identification data used to identify a type of the loaded optical disc;
selecting one of methods of calculating a performance evaluation index based on said identification data;
determining said performance evaluation index by using the selected method; and
evaluating an RF (radio frequency) signal obtained from the loaded optical disc based on said performance evaluation index.

2. The operation method according to claim 1, further comprising:
setting a plurality of identification data of a plurality of kinds of optical discs,
wherein said acquiring an identification data comprises:
extracting said identification data from said plurality of identification data based on a signal obtained from the loaded optical disc.

3. The operation method according to claim 1, wherein said acquiring an identification data comprises:
acquiring said identification data which has been recorded in a predetermined area of the loaded optical disc.

4. The operation method according to claim 1, wherein said acquiring an identification data comprises:
acquiring an optical condition as said identification data from the loaded optical disc, and
said selecting comprises:
determining a wavelength λ of a laser beam and a numerical aperture NA of an object lens based on said optical condition; and
selecting one of the methods of calculating the performance evaluation index based on the determined wavelength λ and numerical aperture NA.

5. The operation method according to claim 4, wherein said selecting one of the methods of calculating the performance evaluation index based on the determined wavelength λ and numerical aperture NA comprises:
selecting a jitter calculating method when λ/NA is larger than 1.4 microns;
selecting a method of calculating the performance evaluation index in a restriction length of 3 or 4 when λ/NA is larger than 0.9 microns and smaller than 1.4 microns; and
selecting a method of calculating the performance evaluation index in the restriction length of 4 or 5 when λ/NA is smaller than 0.9 microns.

6. The operation method according to claim 1, wherein said selecting one of the methods of calculating the performance evaluation index comprises:
selecting one of a plurality of PRML (Partial Response Maximum Likelihood) decoding processes defined based on a plurality of PR (Partial Response) characteristics based on said identification data, and said determining comprises:
determining a PRSNR (Partial Response Signal to Noise Ratio) based on the selected PRML decoding process as the performance evaluation index.

7. The operation method according to claim 1, wherein said selecting one of the methods of calculating the performance evaluation index comprises:
selecting a PR equalization method and a Viterbi detection method from a plurality of PR equalization methods and a plurality of Viterbi detection methods based on said identification data, and said determining comprises:
determining said performance evaluation index by a process using the selected PR equalization method and Viterbi detection method.

8. The operation method according to claim 1, wherein said selecting one of the methods of calculating the performance evaluation index comprises:
selecting one of the methods of calculating SbER (Simulated bit Error Rate) based on the identification data.

9. The operation method according to claim 1, wherein said selecting one of the methods of calculating the performance evaluation index comprises:
selecting a method of calculating jitter based on said identification data.

10. The operation method according to claim 1, further comprising:
adjusting said optical disc apparatus by using the performance evaluation index such that a reproduction data signal can be obtained from the loaded optical disc.

11. The operation method according to claim 10, wherein said adjusting comprises:
carrying out either of a tilt adjustment, a defocus adjustment, a detrack adjustment, a record power adjustment, and a record strategy adjustment.

12. An optical disc apparatus comprising:
an optical head configured to irradiate a laser beam to an optical disc loaded on said optical disc apparatus, and to detect a RF (radio frequency) data signal from said loaded optical disc;
an RF signal processing section configured to calculate a performance evaluation index to said RF signal based on identification data for a type of said loaded optical disc, and to acquire a data signal having been recorded on said loaded optical disc from said RF signal; and
a disc system control section configured to control relative optical position relation of said optical head and said loaded optical disc based on said performance evaluation index.

13. The optical disc apparatus according to claim 12, wherein said disc system control section outputs a control signal to said RF signal processing section based on said identification data, and
said RF signal processing section comprises a plurality of performance evaluation index calculating sections and selects one of said plurality of performance evaluation index calculating sections in response to said control signal from said disc system control section, such that the selected performance evaluation index calculating section calculates said performance evaluation index to said RF signal.

14. The optical disc apparatus according to claim 13, wherein said disc system control section comprises a register set which stores a plurality of identification data to a plurality of kinds of optical discs, extracts one of said plurality of identification data from said register set based on said loaded optical disc, and outputs said control signal to said RF signal processing section based on said identification data.

15. The optical disc apparatus according to claim 13, wherein said disc system control section acquires said identification data which has been recorded in a predetermined area of said optical disc through said optical head, and outputs said control signal to said RF signal processing section based on said identification data.

16. The optical disc apparatus according to claim 13, wherein said optical head outputs said laser beam to said optical disc to acquire said identification data when said optical disc is loaded in said optical disc apparatus, and
said disc system control section outputs said control signal to said RF signal processing section based on a wavelength λ of said laser beam and a numerical aperture NA of an object lens corresponding to said identification data.

17. The optical disc apparatus according to claim 16, wherein said RF signal processing section comprises:
a jitter calculating section configured to calculate a jitter to said RF signal from said optical disc; and
a PRSNR calculating section configured to calculate a PRSNR (Partial Response Signal to Noise Ratio) to said RF signal from said optical disc,
said RF signal processing section:
outputs the jitter calculated by said jitter calculating section as said performance evaluation index, when a value of λ/NA is larger than 1.4 microns,
outputs PRSNR calculated by said PRSNR calculating section under a condition of a restriction length of 3 or 4 as said performance evaluation index, when said value of λ/NA is larger than 0.9 microns and equal to or smaller than 1.4 microns, and
outputs PRSNR calculated by said PRSNR calculating section under a condition of the restriction length of 4 or 5 as said performance evaluation index, when said value of λ/NA is equal to or less than 0.9 microns.

18. The optical disc apparatus according to claim 13, wherein said RF signal processing section comprises:
a plurality of PRSNR calculating sections configured to calculate a plurality of PRSNRs by executing a plurality of PRML (Partial Response Maximum Likelihood) decoding processes defined by a plurality of PR (Partial Response) characteristics, respectively,
one of said plurality of PRSNR calculating sections is selected in response to said control signal, such that the selected PRSNR calculating section executes one of said plurality of PRML decoding processes which is defined by one of said plurality of PR characteristics corresponding to said control signal and calculates the PRSNR as said performance evaluation index.

19. The optical disc apparatus according to claim 18, wherein said PF signal processing section further comprises:
an equalizer configured to generate a plurality of equalization signals to said RF signal from said optical disc; and
a plurality of Viterbi detectors configured to generates Viterbi signals,
said equalizer generates one of said plurality of equalization signals corresponding to said identification data,
one of said plurality of Viterbi detectors generates said Viterbi signal corresponding to said identification data, and
said PRSNR calculating section calculates said PRSNR based on said equalization signal and said Viterbi signal and outputs as said performance evaluation index.

20. The optical disc apparatus according to claim 18, wherein said RF signal processing section further comprises:
a plurality of SbER calculating section configured to calculate SbERs (Simulated bit Error Rate) to said RF signal from said optical disc, respectively, and
one of said plurality of SbER calculating sections corresponding to said identification data calculates said SbER, and
said RF signal processing section outputs said SbER as said performance evaluation index.

21. The optical disc apparatus according to claim 13, wherein said RF signal processing section comprises:
a jitter calculating section configured to calculate a jitter to said RF signal from said optical disc based on said identification data, and
said RF signal processing section outputs the jitter as said performance evaluation index.

22. The optical disc apparatus according to claim 12, wherein said disc system control section executes either of a tilt adjustment, a defocus adjustment, a detrack adjustment, a record power adjustment, and a record strategy adjustment.
